(19) United States
(12) Patent Application Publication
(10) Pub. No.: US 2026/0226901 A1
(43) Pub. Date: Aug. 6, 2026

(54) AXIAL GAP-TYPE ELECTRIC MOTOR EQUIPPED WITH CORELESS STATOR, AND WATER PUMP USING SAME

(71) Applicant: AMOTECH CO., LTD., Incheon (KR)

(72) Inventor: Byung Soo KIM, Incheon (KR)

(21) Appl. No.: 19/153,960

(22) PCT Filed: Feb. 19, 2024
(86) PCT No.: PCT/KR2024/095397

§ 371 Date: Aug. 5, 2025

(30) Foreign Application Priority Data
Feb. 21, 2023 (KR) 10-2023-0023210

(51) Int. Cl. F04D 13/06; F04D 1/04; H02K 1/14; H02K 3/28; H02K 11/33

(52) U.S. Cl. CPC F04D 13/0666; F04D 1/04; F04D 13/0693; H02K 1/146; H02K 3/28; H02K 11/33; H02K 2203/03; H02K 2211/03

(57) ABSTRACT

Provided is a slim axial gap-type electric motor equipped with bobbinless and coreless stators and an electric water pump using same. The axial gap-type electric motor includes: a rotor that is rotatably supported in a fluid flow passage between a pump cover and a body case; a stator that is arranged in a lower space formed by the body case and an upper cover and generates a rotating magnetic field to rotate the rotor; and a partition wall that extends from an upper portion of the inside of the body case to separate the rotor and the stator from each other. The stator includes: 3-phase (U, V, W) coils split and wound in advance into coreless and bobbinless structures; and an auxiliary printed circuit board (PCB) on which the split and wound 3-phase (U, V, W) coils are mounted spaced apart on the same circumference and a plurality of conductive patterns for establishing 3-phase Y-connections of the 3-phase (U, V, W) coils are formed.

### TECHNICAL FIELD

The present invention relates to an axial gap-type electric motor having a coreless type stator, and more particularly, to a slim axial gap-type electric motor having a coreless type stator and an electric water pump using same.

### BACKGROUND ART

Generally, a water pump applied to a vehicle is a device for circulating cooling water. The water pump is forcibly driven by a belt to suck and discharge cooling water by rotating a pump impeller, thereby circulating cooling water. An engine-driven water pump or an electric water pump is representatively used in the inside of the water pump. The engine-driven water pump is assembled with a seal unit therein to prevent leakage of cooling water, and the electric water pump is driven by an electric motor driven by electricity provided by a battery or the like, and circulates cooling water by rotating an impeller by the electric motor to suck and discharge the cooling water.

In addition, since the electric water pump does not require the engine driving force of the vehicle compared to the engine-driven water pump, the engine efficiency is increased compared to the engine-driven water pump, and thus fuel efficiency is improved, and furthermore, the temperature of the cooling water may be precisely controlled, thereby being widely applied to various kinds of vehicles.

In addition, in the case of an electric vehicle, a hybrid vehicle, or a fuel cell vehicle, the importance of the electric water pump grows increasingly as compared with the engine-driven water pump because driving of a vehicle is executed even at a state where driving of an engine stops (in the case of a hybrid vehicle), or even an engine for driving the water pump is not provided (in the case of an electric vehicle or a fuel cell vehicle).

Meanwhile, among the electric water pumps, a canned type electric water pump is a pump driven by an electric motor having a can-shaped sealing container inside a stator. The canned type electric water pump has a structure in which a can structure is inserted between a rotor and a stator, and a hydraulic unit is extended to the rotor so that the rotor is immersed in the cooling water, thereby appropriately cooling, through the cooling water contacting the rotor, the frictional heat generated from the rotor.

In the Korean Patent Application Publication No. 10-2021-0108845 (Patent Document 1), there is provided an axial gap-type electric motor for an electric water pump (EWP) including: a rotor rotatably supported on a fluid flow passage between a pump cover and a body case; a stator arranged in a lower space formed by the body case and an upper cover, and generating a rotating magnetic field to rotatably drive the rotor; and a partition arranged on upper of the body case to separate between the rotor and the stator, wherein the rotor includes a non-rare earth magnet.

In the conventional electric motor structure of Patent Document 1, a stator core of a stator includes: a plurality of teeth each formed in a “T” shape and made of soft magnetic composites (SMC) powders; and a back yoke formed by stacking a plurality of electrical steel sheets that interconnect the plurality of teeth, so there is a problem of poor assembly productivity.

In addition, since the conventional axial gap-type electric motor for a water pump has a stator core arranged in parallel with an axial direction, it is very difficult for the water pump to have a slim structure in the axial direction.

### DISCLOSURE

### Technical Problem

Accordingly, to solve the conventional problems, it is an objective of the present invention to provide a slim axial gap-type electric motor having a bobbinless and coreless type stator, and a water pump using same.

It is another objective of the present invention to provide a slim axial gap-type electric motor and a water pump using same, wherein a plurality of coils of a coreless and bobbinless structure that does not use a stator core and a bobbin are assembled using an auxiliary printed circuit board (PCB) for wiring coils instead of the bobbin and a three-phase Y-connection (neutral point) brushless direct-current (BLDC) motor may be easily implemented and assembled with the plurality of coils by using the auxiliary printed circuit board (PCB).

It is another objective of the present invention to provide a slim axial gap-type electric motor which is designed for waterproofing with a simple structure and capable of fully waterproofing, and a water pump using same.

It is another objective of the present invention to provide a slim axial gap-type electric motor and a water pump using same, wherein a rotor and a stator are separated by using a partition wall of a thin plate between the rotor and the stator, to thereby reduce an air gap, and thus a magnetic energy equivalent to that of an electric motor using a rare earth magnet even though a ferrite magnet, which is a non-rare earth magnet, is used, may be provided.

### Technical Solution

According to an aspect of an embodiment of the present invention, there is provided an axial gap-type electric motor for an electric water pump (EWP) including: a rotor rotatably supported on a fluid flow passage between a pump cover and a body case; a stator arranged in a lower space formed by the body case and an upper cover, and generating a rotating magnetic field to rotatably drive the rotor, and a partition wall that extends from an upper portion of the inside of the body case to separate the rotor and the stator from each other, wherein the stator includes: 3-phase (U, V, W) coils split and wound in advance in a fan shape and having a through-hole therein in coreless and bobbinless structures; and an auxiliary printed circuit board (PCB) on which the split and wound 3-phase (U, V, W) coils are mounted spaced apart on the same circumference and a plurality of conductive patterns for establishing 3-phase Y-connections of the 3-phase (U, V, W) coils are formed, wherein start lines of the 3-phase (U, V, W) coils are respectively connected to 3-phase (U, V, W) output terminals of an inverter circuit, and end lines of the 3-phase (U, V, W) coils are commonly connected to each other to form a Y-connection neutral point (COM).

When the 3-phase (U, V, W) coils are split into six windings and configure a parallel connection circuit for each phase of U, V, and W, the plurality of conductive patterns may include: first to third conductive patterns arranged outside the auxiliary printed circuit board (PCB) and connected to start lines of the 3-phase (U, V, W) coils arranged outside the split and wound 3-phase (U, V, W) coils, respectively, to configure a parallel connection circuit for each phase; and a circular conductive pattern arranged around a through-hole formed in a central portion of the auxiliary printed circuit board (PCB) and having end lines of the 3-phase (U, V, W) coils arranged inside the 3-phase (U, V, W) coils connected in common to form a Y-connection type neutral point (N) of the 3-phase (U, V, W) coils.

In addition, one-end portions of the first to third conductive patterns may be connected to the 3-phase (U, V, W) output terminals of the inverter circuit to apply a driving current to the 3-phase (U, V, W) coils through external terminals, respectively.

Moreover, the electric motor may include a BLDC motor having a 12-pole-9 slot or an 8-pole-6 slot structure, and the 3-phase (U, V, W) coils may be split and wound in 9 or 6 windings and may form a serial connection circuit or a parallel connection circuit for each phase of U, V, and W.

The axial gap-type electric motor for a water pump (EWP) according to an embodiment of the present disclosure may further include an annular back yoke installed under the auxiliary printed circuit board (PCB) to form a magnetic circuit.

In addition, the axial gap-type electric motor for a water pump (EWP) according to an embodiment of the present invention may further include a heat dissipation molding part made of an insulating heat dissipation composite material capable of increasing insulation and heat dissipation performance while surrounding the upper portion of the stator.

In addition, an axial gap-type electric motor for a water pump (EWP) according to another embodiment of the present invention may further include: a support shaft accommodation part formed to extend to the lower space to form a groove from the center of the partition wall; a support shaft having a lower end portion fixed through the groove of the support shaft accommodation part; a bearing housing extending from the center of the rotor support supporting the rotor to the inside of the groove of the support shaft accommodation part; and a sleeve bearing installed at an inner circumferential portion of the bearing housing to rotatably support the rotor about the support shaft.

According to another aspect of an embodiment of the present invention there is provided a water pump including: a pump housing having a space in a sealing state on one side thereof, in which, on the other side thereof, an inlet through which a fluid is introduced and an outlet through which the introduced fluid is discharged are connected through a fluid flow passage; a rotor rotatably supported on the fluid flow passage; an impeller integrally formed with the rotor on an upper side of the rotor; a stator arranged in the lower space to generate a rotating magnetic field to rotatably drive the rotor; and a partition wall arranged inside the pump housing to separate the rotor from the stator, wherein the rotor and the stator form an axial gap-type electric motor, and the stator includes: 3-phase (U, V, W) coils split and wound in advance in a fan shape and having a through-hole therein in coreless and bobbinless structures; and an auxiliary printed circuit board (PCB) on which the split and wound 3-phase (U, V, W) coils are mounted spaced apart on the same circumference and a plurality of conductive patterns for establishing 3-phase Y-connections of the 3-phase (U, V, W) coils are formed, wherein start lines of the 3-phase (U, V, W) coils are respectively connected to 3-phase (U, V, W) output terminals of an inverter circuit, and end lines of the 3-phase (U, V, W) coils are commonly connected to each other to form a Y-connection neutral point (COM).

When the 3-phase (U, V, W) coils are split into six windings and configure a parallel connection circuit for each phase of U, V, and W, the plurality of conductive patterns may include: first to third conductive patterns arranged outside the auxiliary printed circuit board (PCB) and connected to start lines of the 3-phase (U, V, W) coils arranged outside the split and wound 3-phase (U, V, W) coils, respectively, to configure a parallel connection circuit for each phase; and a circular conductive pattern arranged around a through-hole formed in a central portion of the auxiliary printed circuit board (PCB) and having end lines of the 3-phase (U, V, W) coils arranged inside the 3-phase (U, V, W) coils connected in common to form a Y-connection type neutral point (N) of the 3-phase (U, V, W) coils.

The pump housing may include: a pump cover at the center of one side end of which an inlet through which a fluid such as cooling water is introduced is arranged, at one side of which an outlet through which the introduced fluid is discharged is extended, and the center of the other end of which is open; a body case which covers the opening of the pump cover by the partition wall to form a fluid flow passage inside the pump cover, and is formed in an inverted cup shape so as to have a lower space outside the lower side of the fluid flow passage; and an upper cover coupled to a lower side of the body case to form a sealed lower space therein, and having the stator of the electric motor embedded in the lower space.

In this case, the magnet of the rotor may be an open structure exposed to the fluid, and the magnet of the rotor may be a ferrite magnet.

### Advantageous Effects

As described above, in the axial gap-type electric motor of the present invention, a slim structure may be realized by including a bobbinless and coreless type stator.

In a general stator, a back yoke is arranged below a stator coil, and coil wiring for a Y-connection (neutral point) for a three-phase BLDC motor is performed using a bobbin on which a coil winding is formed.

According to the present invention, in order to reduce assemblability and price, a plurality of coils having a coreless and bobbinless structure which do not use a stator core and a bobbin are assembled by using an auxiliary printed circuit board (PCB) for coil wiring, instead of a bobbin, and the plurality of coils may be easily implemented into a Y-connection neutral point (COM) of the 3-phase (U, V, W) coils, by using the auxiliary printed circuit board (PCB).

In addition, since the conventional axial gap-type electric motor for a water pump has a stator core arranged in parallel with an axial direction, it is very difficult for the water pump to have a slim structure in the axial direction. In the present invention, it is possible to realize a slim structure by providing a coreless type stator having a coreless and bobbinless structure and simultaneously placing a main printed circuit board (PCB) for a motor driving circuit on the outside.

Moreover, according to the present invention, the rotor and the stator are separated by the partition of the body case in which the stator is embedded, and thus the rotor is designed in a simple structure, thereby enabling complete waterproof implementation.

In addition, in the present invention, as the rotor and the stator are separated by using the thin partition, a ferrite magnet which is an inexpensive non-rare earth magnet may be used as a magnet of the rotor.

According to the present invention, it is possible to reduce the air gap by separating the rotor and the stator with each other by using the partition wall of the thin plate, so that even if a ferrite magnet, which is a non-rare earth magnet, is used, a magnetic energy is equivalent to that of an electric motor using a rare earth magnet including Nd.

Furthermore, the electric motor of the present invention may use a non-rare earth magnet having an open structure without the need of a separate magnet waterproof structure required when the rotor is exposed to the fluid in the fluid flow passage. Accordingly, in the electric motor of the present invention, an air gap may be further reduced compared to a conventional motor employing a rare earth magnet to increase motor efficiency.

### BRIEF DESCRIPTION OF THE DRAWINGS

FIG. 1 is a perspective view of a water pump using an axial gap-type electric motor according to an embodiment of the present invention.

FIG. 2 is a front view of a water pump using an axial gap-type electric motor according to an embodiment of the present invention.

FIG. 3 is a cross-sectional view of line A-A of FIG. 2.

FIG. 4 is a plan view of a water pump using an axial gap-type electric motor according to an embodiment of the present invention.

FIGS. 5 and 6 are cross-sectional views taken along lines B-B and C-C of FIG. 4, respectively.

FIG. 7 is an exploded perspective view of each assembly of a water pump using an axial gap-type electric motor according to an embodiment of the present invention.

FIGS. 8 and 9 are a perspective view and an exploded perspective view of a stator for an axial gap-type electric motor according to an embodiment of the present invention, respectively.

FIGS. 10A and 10B are equivalent circuit diagrams of an auxiliary PCB and a stator coil of a stator according to an embodiment of the present invention, respectively.

### BEST MODE FOR CARRYING OUT THE INVENTION

Hereinafter, embodiments of the present disclosure will be described in detail with reference to the accompanying drawings.

The sizes and shapes of the components shown in the drawings may be exaggerated for clarity and convenience. In addition, terms defined in consideration of the configuration and operation of the present disclosure may vary depending on the intention or custom of the user, the operator, and the like. Definitions of these terms should be based on the content of this specification.

An axial gap-type motor employing a rare-earth-free magnet according to an embodiment of the present invention may be implemented as a longitudinal-axis type motor, and is applied to an electric water pump (EWP), a compressor, an oil pump, etc., containing the motor therein, and an example in the following description will be described with respect to the case in which the axial gap-type motor is applied to the water pump (EWP).

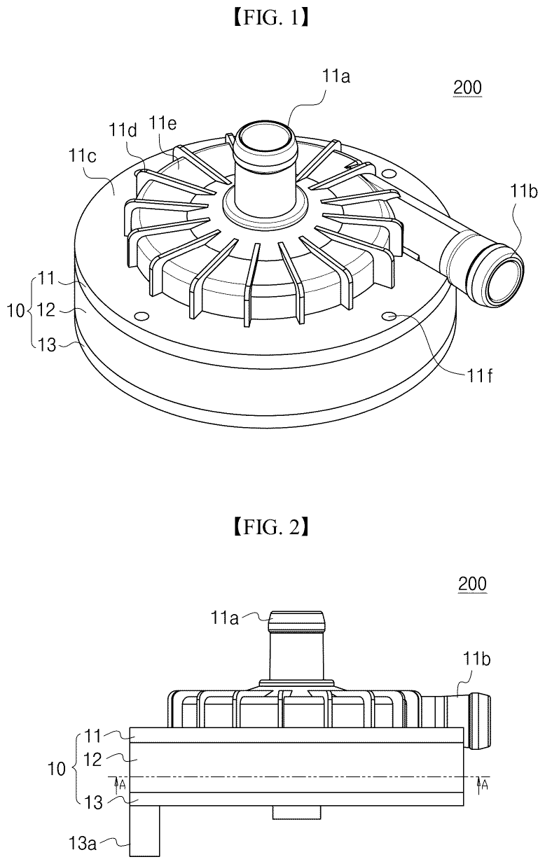

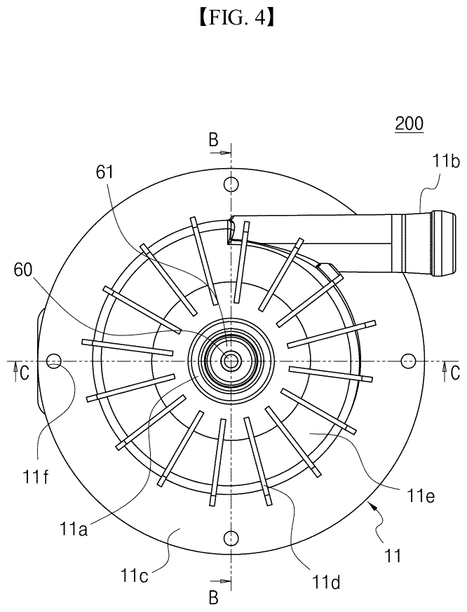

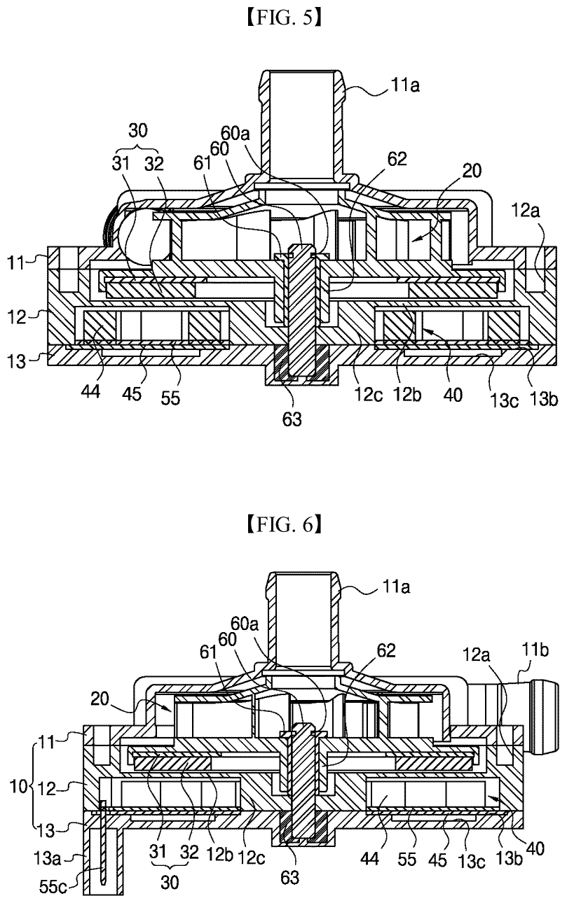

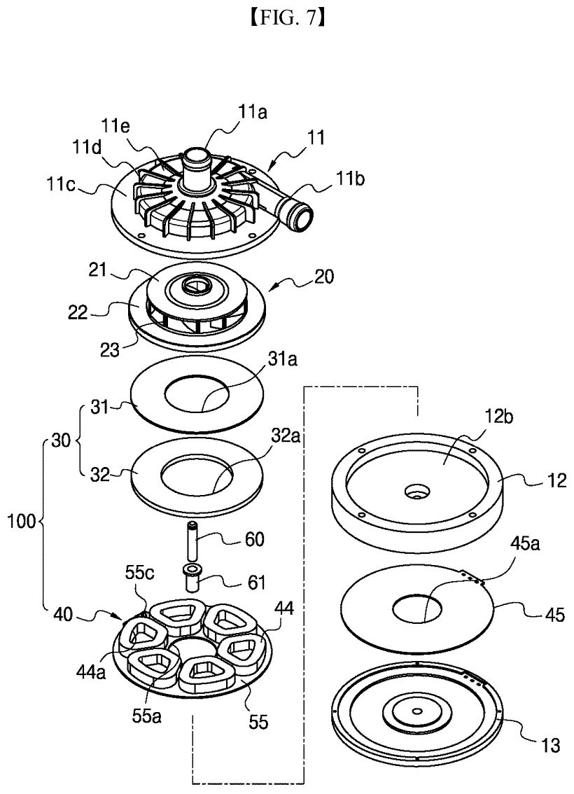

Referring to FIGS. 1 to 9, the water pump (EWP) 200 using the axial gap-type electric motor according to the present invention largely includes a pump housing 10, an axial gap-type electric motor 100, and an impeller 20.

The pump housing 10 includes: a pump cover 11 having an inlet 11a through which a fluid, such as cooling water, is introduced, and which is arranged at the center of one end thereof, and an outlet 11b through which the introduced fluid is discharged, and which is extended and formed at one side surface thereof, and the central portion of the other end thereof is opened; an inverted cup-shaped body case 12 that covers the opening of the pump cover 11 to form a fluid flow passage P inside the pump cover 11 and to have a lower space 14 outside the fluid flow passage P; and an upper cover 13 coupled to a lower end of the body case 12, in which the stator 40 of the electric motor 100 is embedded in the lower space 14 sealed from inside the body case 12.

In the present invention, a driver for driving a stator 40 may be arranged outside the pump housing 10 to form a slim water pump 200. However, the driver may be arranged inside the pump housing 10.

The pump cover 11 and the body case 12 preferably have a cylindrical shape and have a coupling structure fixed to each other. For mutual fixing and coupling between the pump cover 11 and the body case 12, for example, three fixing screws or fixing bolts are respectively fastened to coupling holes 11f formed in the outer circumferential portions of the pump cover 11 and the body case 12.

In addition, a sealing O-ring may be inserted into an outer circumferential portion where the pump cover 11 and the body case 12 are bonded to each other.

Moreover, a plurality of fixing screws or fixing bolts may be used between the body case 12 and the upper cover 13 such that the body case 12 and the upper cover 13 are fixed and coupled to each other, and a sealing O-ring may be inserted between the body case 12 and the upper cover 13 to maintain a sealed state of the lower space 14.

In addition, a groove 12d for accommodating one-side protrusion 55b of an auxiliary printed circuit board (PCB) 55, which will be described later, is provided at an inner circumferential portion of the body case 12.

In addition, an annular first-step groove 13b in which an annular back yoke 45 of the stator 40 is seated and accommodated and an annular second-step groove 13c forming a space between the back yoke 45 and the upper cover 13 are formed on the upper surface of the upper cover 13.

A connector housing 13a for applying a driving signal from a driver (a motor driving circuit) arranged outside to an external terminal 55c of the auxiliary printed circuit board (PCB) 55 is integrally extended below one side of the upper cover 13.

The pump cover 11, the body case 12, and the upper cover 13 forming the pump housing 10 may be formed of, for example, a resin such as polyphenylene sulfide (PPS).

The impeller 20 in which the rotor 30 of the electric motor 100 is integrally formed at the lower side of the fluid flow passage P is arranged in the fluid flow passage P of the 90-degree bent portion between the inlet 11a and the outlet 11b of the pump cover 11.

In addition, the open lower end of the pump cover 11 is extended to secure a larger space than the inlet 11a so that the impeller 20 may be arranged in the fluid flow passage P, and a groove structure is formed so that the rotor 30 integrally formed on the lower side of the impeller 20 may be arranged above the body case 12 corresponding to the open lower end of the pump cover 11.

A plurality of wings 23 are radially arranged between the disk-shaped upper plate 21 and the lower plate 22 to discharge a fluid such as cooling water introduced from the inlet 11a through the outlet 11b arranged at the side surface of the pump cover 11. The upper plate 21 has a through hole formed at the center thereof and a diameter of the upper plate 21 increases from the upper side to the lower side, in a narrow-top and wide-bottom form, and the lower plate 22 has a circular plate surrounding the upper side and the outer side of the rotor 20.

The pump cover 11 has a flange 11c extending on the lower end portion thereof from a body 11e accommodating the impeller 20 therein so as to have the same outer diameter as the outer diameter of the body case 12. A plurality of strength reinforcing ribs 11d are radially formed on an outer circumferential surface of the body 11e to reinforce the strength of the body 11e.

Accordingly, the lower plate 22 has a diameter larger than that of the upper plate 21 in correspondence to the diameter of the flange 11c, so that the outer circumference of the lower plate 22 acts as a rotor support while surrounding the outer circumference of the rotor 30. In this case, the lower plate 22 serving as the rotor support and the rotor 30 may be integrated by an insert molding method when formed using, for example, a resin such as poly polyphenylene sulfide (PPS).

In addition, a bearing housing 62 is formed in the center of the lower plate (i.e., the rotor support) 22 to extend into the groove of a support shaft accommodation part 12c, which will be described later, and a sleeve bearing 61 rotatably supporting the rotor 30 on a support shaft 60 is installed at an inner circumferential portion of a through hole formed in the center of the bearing housing 62.

It is desirable to use an oil-less bearing, such as a carbon bearing or a plastic bearing in consideration of the fact that the sleeve bearing 61 is in contact with the fluid.

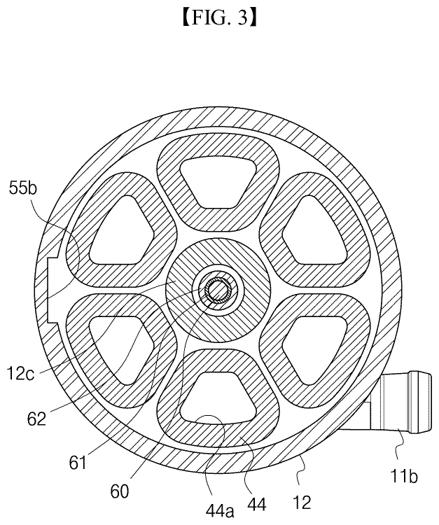

Meanwhile, as shown in FIGS. 3 to 10B, as a driving means for rotating the impeller 20, a water pump (EWP) 200 according to the present invention employs an axial gap-type electric motor 100, which includes a coreless stator 40 arranged in a sealed lower space 14 inside a body case 12 and a rotor 30 arranged to face the stator 40 in the fluid flow passage P outside the body case 12.

First, the rotor 30 has the ring-shaped back yoke 31 and the magnet 32 installed sequentially on the lower surface of the lower plate 22 to form a single body with the impeller 20. The magnet 32 of the rotor 30 may include a plurality of N-pole and S-pole split magnet segments, or may use a magnet in which the N-pole and S-pole are split and magnetized into multiple poles in a ring-shaped magnet. The back yoke 31 may be, for example, an electro galvanized iron (EGI) steel sheet, and is installed on the rear surface of the magnet 32 to form a magnetic circuit. Through-holes 31a and 32a are formed in the centers of the back yoke 31 and the magnet 32, respectively.

A thin partition wall 12b for separating the stator 40 and the rotor 30 is installed on the body case 12 to implement a complete waterproof structure for the stator 40. That is, the thin partition wall 12b separating the stator 40 and the rotor 30 from each other may completely block the stator 40 arranged in the sealed lower space 14 inside the body case 12 from being in contact with the cooling water.

When compared to the cylindrical portion of the body case 12, the partition wall 12b may reduce an air gap between the stator 40 and the rotor 30, as described below, by forming a relatively thin partition wall 12b so that a ferrite magnet, which is a non-rare earth magnet, may be used as a magnet of the rotor 30.

In other words, the electric motor 100 of the present invention has an axial gap-type in which the rotor 30 and the stator 40 face each other with the thin partition wall 12b therebetween, and may be used as an open structure in which cooling water contacts the magnet without the need for a separate magnet waterproof structure required when using a rare earth magnet. In this case, as the electric motor 100 according to the present invention uses a ferrite magnet as the magnet 32 of the rotor 30, which is a non-rare earth magnet that does not rust, the performance the magnet does not deteriorate even if the ferrite magnet is operated for a long time in contact with the cooling water flowing along the fluid flow passage (P) inside the pump cover 11. Accordingly, the electric motor 100 of the present invention may further reduce an air gap compared to an electric motor employing a rare earth magnet having a magnet waterproof structure to thereby increase efficiency of the motor.

In addition, in the present invention, when a vertical type electric motor having the same outer diameter as a general internal electric motor is applied, it is possible to reduce an air gap by separating the rotor 30 and the stator 40 from each other by using the thin partition wall 12b between the rotor 30 and the stator 40, thereby implementing an axial gap-type electric motor having magnetic energy equivalent to that of an electric motor using a rare earth magnet including Nd even if a ferrite magnet, which is a non-rare earth magnet, is used.

The support shaft 60 may be integrated by insert molding in which a lower portion of the support shaft 60 is inserted into a central portion of the partition wall 12b when the body case 12 is injection-molded, or may be press-fitted and fixed to penetrate a grooved bottom of a support shaft accommodation part 12c integrally formed at the central portion of the partition wall 12b.

The support shaft accommodation part 12c extends to the lower space 14 to form a groove from the center of the partition wall 12b, and the bearing housing 62 extends from the center of the lower plate 22, that is, the center of the rotor support, to the groove of the support shaft accommodation part 12c. As a result, as the sleeve bearing 61 and the support shaft 60 are formed to have a sufficient length and a sufficient contact area, the rotor 30 may be supported to be stably rotated.

A lower end portion of the support shaft 60 may be supported by a thrust bearing 63 installed on the upper cover 13, and a groove 60a to which a snap ring for preventing the sleeve bearing 61 from being separated is formed at an upper portion of the support shaft 60.

Hereinbelow, the stator 40 of an axial gap-type electric motor 100 according to an embodiment of the present invention will be described.

As shown in FIGS. 3 to 10B, the stator 40 is installed in the lower space 14 maintaining the sealing state, and is arranged to face the rotor 30 in the axial direction with the thin partition wall 12b therebetween to form an axial gap-type electric motor 100.

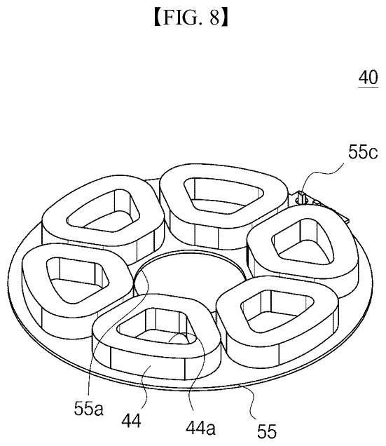

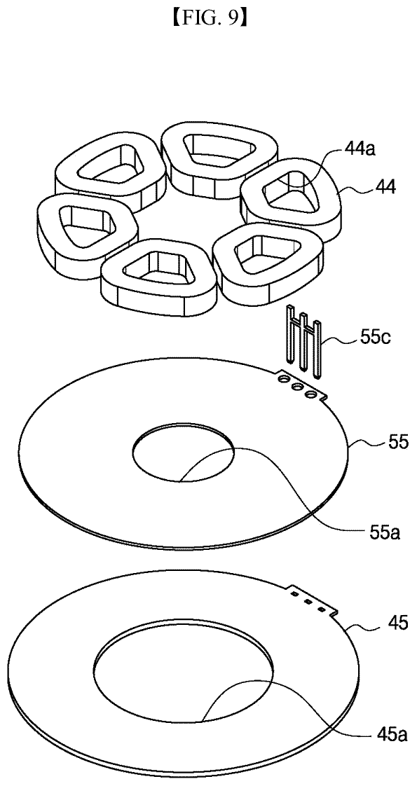

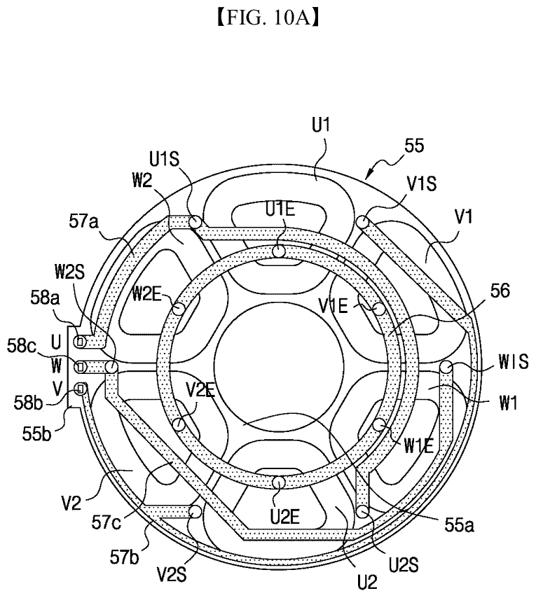

As shown in FIGS. 8 and 9, the stator 40 includes a plurality of coils 44 having a coreless and bobbinless structure, an auxiliary printed circuit board (PCB) 55 for forming a Y-connection neutral point COM required to implement a three-phase driving type BLDC motor by assembling the plurality of coils 44, and a back yoke 45 for forming a magnetic circuit.

In a general stator, a back yoke is arranged below a stator coil, and coil wiring for a Y-connection (neutral point) is performed using a bobbin on which a coil winding is formed.

In the stator 40 according to the present invention, in order to reduce assemblability and price, a plurality of coils 44 having a coreless and bobbinless structure which do not use a stator core and a bobbin are assembled by using an auxiliary printed circuit board (PCB) 55 for coil wiring, instead of a bobbin, and the plurality of coils 44 may be easily implemented into a Y-connection neutral point (COM) of the 3-phase (U, V, W) coils, by using the auxiliary printed circuit board (PCB) 55.

As a result, the stator 40 of the present invention may realize a slim structure by implementing a coreless stator.

In the water pump 200 according to the present invention, the axial gap-type electric motor 100 may be composed of, for example, a brushless direct-current (BLDC) motor having a 12-pole-9-slot or 8-pole-6-slot structure. In the case that the electric motor 100 has an 8-pole-6-slot structure, when the coils 44 of the stator 40, that is, six coils 44 of the 3-phase (U, V, W) coils are wound in advance without using the teeth and the bobbin, to constitute a circuit, two coils (U1-U2, V1-V2, W1-W2) given for each phase may be configured in the form of a serial connection or a parallel connection.

In this case, the plurality of coils 44 are wound in a fan shape and have a fan-shaped through hole 44a therein.

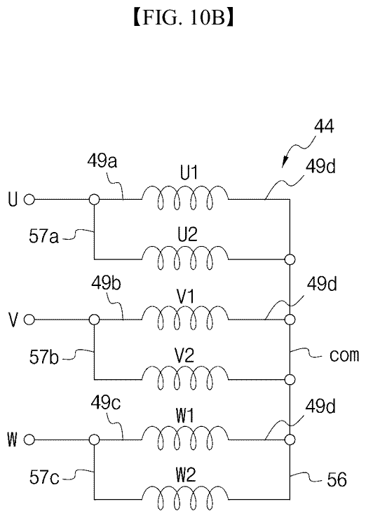

Two wound coils (U1-U2, V1-V2, W1-W2) are connected in parallel for each phase of U, V, and W phases, and the three-phase driving circuit is connected by using the auxiliary printed circuit board (PCB) 55 in a Y-connection manner, which may be illustrated in FIG. 10B, and FIG. 10A is a pattern diagram of the auxiliary printed circuit board (PCB) 55 for implementing an equivalent circuit of the parallel-connected stator coils 44 shown in FIG. 10B.

As illustrated in FIG. 10B, coils (U1-U2, V1-V2, W1-W2) of each phase are connected in parallel, and thus start lines 49a to 49c of each phase are interconnected, and end lines 49d of all coils (U1-U2, V1-V2, W1-W2) are interconnected to form a Y-connection neutral point COM.

To this end, the auxiliary printed circuit board (PCB) 55 is formed in an annular shape as shown in FIG. 10A, and a circular conductive pattern 56 and three U-phase, V-phase, and W-phase conductive patterns 57a to 57c are formed around the through-hole 55a formed in the center portion thereof.

In the U-phase, V-phase, and W-phase conductive patterns 57a to 57c, the W-phase conductive pattern 57c is arranged along the outermost edge of the auxiliary printed circuit board (PCB) 55, the V-phase conductive pattern 57b is arranged inside the W-phase conductive pattern 57c, and the U-phase conductive pattern 57a is partially arranged along the outer edge of the auxiliary printed circuit board (PCB) 55 and then is arranged along the outer edge of the circular conductive pattern 56.

The U1-U2, V1-V2, and W1-W2 coils 44 have U-phase, V-phase, and W-phase coils alternately arranged along the substrate direction. The start lines 49a to 49c of the U1-U2, V1-V2, and W1-W2 coils 44 are connected to the first and second start terminals (U1S, U2S; V1S, V2S; and W1S, W2S) of the U-phase, V-phase, and W-phase conductive patterns 57a to 57c placed outside the substrate. The end lines 49d of the U1-U2, V1-V2, and W1-W2 coils 44 are each placed inside the coils 44 to form a Y-connection line (neutral point), and connected to the first and second end terminals (U1E, U2E; V1E, V2E; and W1E, W2E) of the circular conductive pattern 56 forming the common electrode COM.

In addition, the other ends of the U-phase, V-phase, and W-phase conductive patterns 57a to 57c are respectively connected to the three-phase (U, V, W) output terminals (Uout, Vout, and Wout) of an inverter circuit provided in a motor driving circuit (driver) outside the water pump (EWP) 200 through the external terminal 55c, which has one end coupled to the U-phase, V-phase, and W-phase external connection terminals 58a to 58c arranged on one-side protrusion 55b of the auxiliary printed circuit board (PCB) 55.

Further, the motor 100 may be driven by a 6-step propagation driving method using an inverter, for example.

When the axial gap-type electric motor 100 is driven in a three-phase (U, V, W) driving system, for example, the rotation position of the rotor 130 may be sensed using a Hall sensor as a rotor position sensing element. To this end, when the rotor 30 rotates, the rotation position of the rotor 30 may be sensed by a Hall sensor assembly installed in the auxiliary printed circuit board (PCB) 55. The rotor position sensing element for sensing the position signal of the rotor may use, for example, two or three Hall sensor devices, in the three-phase driving system. The Hall sensor assembly may have a structure in which three Hall sensors and peripheral circuit elements are mounted on an auxiliary printed circuit board (PCB) 55.

In addition, the axial gap-type electric motor 100 may use a sensorless type motor driving circuit without using a Hall sensor.

The stator 40 thus obtained may form a heat dissipation molding part by performing insert molding using an insulating heat dissipation composite material capable of increasing insulation and heat dissipation performance while surrounding the upper portion of the stator 40.

The heat dissipation molding part surrounding the stator 40 may preferably include an insulating heat dissipation composite material having heat dissipation performance and insulating performance at the same time. In this case, it is possible to use general plastic as a molding material surrounding the stator 40.

The stator 40 preferably has an insulation performance of at least 10 Kv or more, and the thermal conductivity is preferably 3 W/mK or more in consideration of heat dissipation characteristics.

Bulk Molding Compound (BMC), which is a thermosetting plastic material, may be used as the insulating heat dissipation composite material.

A driver for generating a rotating magnetic field by applying a driving signal to the three-phase coils of the stator 40 may be installed under the stator 40, but it is omitted for slimming in the drawings of the present embodiment, and the driver is installed outside the pump.

As described above, the axial gap-type electric motor 100 for a water pump 200 according to the present invention has a structure in which the stator 40 is placed in the lower space 14 inside the body case 12, which is a waterproof space completely separated from the fluid flow passage P inside the pump cover 11, the rotor 30 is integrally formed with the impeller 20 and arranged in the fluid flow passage P, and the stator 40 and the rotor 30 have a structure separated by the thin partition wall 12b.

In addition, when a water pump control signal is applied to the driver from a control device of the water pump 200 placed inside the vehicle, in the axial gap-type electric motor 100, the driver applies the driving signal for the plurality of coils 44 of the axial gap-type electric motor 100 from the driver when receiving the rotor position signal from the Hall sensor (not shown), and the stator 40 generates a rotating magnetic field from the plurality of coils 44.

When a rotating magnetic field is generated from the plurality of coils 44 of the stator 40, the rotor 30 arranged in the fluid flow passage P through the partition wall 12b rotates around the support shaft 60 together with the impeller 20. As a result, cooling water is introduced from the inlet 11a of the pump cover 11 according to the rotation of the impeller 20, and the introduced cooling water is discharged to the outlet 11b along the fluid flow passage P.

In the present invention, complete waterproofing of the stator 40 of the electric motor 100 may be realized by driving the impeller 20 and the rotor 30 arranged inside the fluid flow passage P in a magnetic-coupling manner by the stator 40 of the electric motor 100 arranged outside the fluid flow passage P.

Furthermore, in the present disclosure, since the stator 40 of the electric motor 100 is completely separated from the fluid flow passage P, a separate waterproof process for the rotor 30 may be omitted, and accordingly, an air gap between the rotor 30 and the stator 40 of the electric motor 100 may be set to an optimal state to promote efficiency of the electric motor 100.

In addition, according to the present invention, since the stator 40 of the electric motor is completely isolated from the fluid flow passage P, it is possible to support the support shaft 60 of the electric motor by a general bearing which does not employ the waterproof structure, thereby reducing costs and improving durability.

The present invention may have magnetic energy equivalent to that of a motor using a rare earth magnet even when a ferrite magnet, which is a non-rare earth magnet, is used by applying a longitudinal axis type motor having the same external diameter as an inner-rotor type motor.

While the present disclosure has been particularly shown and described with reference to exemplary embodiments thereof, by way of illustration and example only, it is clearly understood that the present disclosure is not to be construed as limiting the present disclosure, and various changes and modifications may be made by those skilled in the art within the protective scope of the invention without departing off the spirit of the present disclosure.

### INDUSTRIAL APPLICABILITY

This invention relates to an axial gap-type electric motor, and in particular, the electric motor may be applied to hybrid, electric, and fuel cell vehicles, and may be applied to electric water pumps (EWP), compressors, and oil pumps for cooling devices that circulate cooling water in electronic components, batteries, and fuel cell stacks.

What is claimed is:

1. An axial gap-type electric motor comprising:
a rotor rotatably supported on a fluid flow passage between a pump cover and a body case;
a stator arranged in a lower space formed by the body case and an upper cover, and generating a rotating magnetic field to rotatably drive the rotor; and
a partition wall that extends from an upper portion of the inside of the body case to separate the rotor and the stator from each other, wherein the stator comprises:
3-phase (U, V, W) coils split and wound in advance in a fan shape and having a through-hole therein in coreless and bobbinless structures; and
an auxiliary printed circuit board (PCB) on which the split and wound 3-phase (U, V, W) coils are mounted spaced apart on the same circumference and a plurality of conductive patterns for establishing 3-phase Y-connections of the 3-phase (U, V, W) coils are formed, wherein start lines of the 3-phase (U, V, W) coils are respectively connected to 3-phase (U, V, W) output terminals of an inverter circuit, and end lines of the 3-phase (U, V, W) coils are commonly connected to each other to form a Y-connection neutral point (COM).

2. The axial gap-type electric motor of claim 1, wherein, when the 3-phase (U, V, W) coils are split into six windings and configure a parallel connection circuit for each phase of U, V, and W, the plurality of conductive patterns comprises:
first to third conductive patterns arranged outside the auxiliary printed circuit board (PCB) and connected to start lines of the 3-phase (U, V, W) coils arranged outside the split and wound 3-phase (U, V, W) coils, respectively, to configure a parallel connection circuit for each phase; and
a circular conductive pattern arranged around a through-hole formed in a central portion of the auxiliary printed circuit board (PCB) and having end lines of the 3-phase (U, V, W) coils arranged inside the 3-phase (U, V, W) coils connected in common to form a Y-connection type neutral point (N) of the 3-phase (U, V, W) coils.

3. The axial gap-type electric motor of claim 1, wherein one-end portions of the first to third conductive patterns are connected to the 3-phase (U, V, W) output terminals of the inverter circuit to apply a driving current to the 3-phase (U, V, W) coils through external terminals, respectively.

4. The axial gap-type electric motor of claim 1, wherein the electric motor comprises a BLDC motor having a 12-pole-9 slot, or an 8-pole-6 slot structure, and the 3-phase (U, V, W) coils are split into and wound on nine or six windings and form a series connection circuit or parallel connection circuit for each of U, V, and W phases.

5. The axial gap-type electric motor of claim 1, further comprising an annular back yoke arranged under the auxiliary printed circuit board (PCB) to form a magnetic circuit.

6. The axial gap-type electric motor of claim 1, further comprising a heat dissipation molding part made of an insulating heat dissipation composite material capable of increasing insulation and heat dissipation performance while surrounding an upper portion of the stator.

7. The axial gap-type electric motor of claim 1, further comprising:
a support shaft accommodation part formed to extend to the lower space to form a groove from the center of the partition wall;
a support shaft having a lower end portion fixed through the groove of the support shaft accommodation part;
a bearing housing extending from the center of the rotor support supporting the rotor to the inside of the groove of the support shaft accommodation part; and
a sleeve bearing installed at an inner circumferential portion of the bearing housing to rotatably support the rotor about the support shaft.

8. A water pump comprising:
a pump housing having a space in a sealing state on one side thereof, in which, on the other side thereof, an inlet through which a fluid is introduced and an outlet through which the introduced fluid is discharged are connected through a fluid flow passage;
a rotor rotatably supported on the fluid flow passage;
an impeller integrally formed with the rotor on an upper side of the rotor;
a stator arranged in the lower space to generate a rotating magnetic field to rotatably drive the rotor; and
a partition wall arranged inside the pump housing to separate the rotor from the stator, wherein
the rotor and the stator form an axial gap-type electric motor, and
the stator comprises: 3-phase (U, V, W) coils split and wound in advance in a fan shape and having a through-hole therein in coreless and bobbinless structures; and an auxiliary printed circuit board (PCB) on which the split and wound 3-phase (U, V, W) coils are mounted spaced apart on the same circumference and a plurality of conductive patterns for establishing 3-phase Y-connections of the 3-phase (U, V, W) coils are formed, wherein
start lines of the 3-phase (U, V, W) coils are respectively connected to 3-phase (U, V, W) output terminals of an inverter circuit, and end lines of the 3-phase (U, V, W) coils are commonly connected to each other to form a Y-connection neutral point (COM).

9. The water pump of claim 8, wherein when the 3-phase (U, V, W) coils are split into six windings and configure a parallel connection circuit for each phase of U, V, and W, the plurality of conductive patterns comprise:
first to third conductive patterns arranged outside the auxiliary printed circuit board (PCB) and connected to start lines of the 3-phase (U, V, W) coils arranged outside the split and wound 3-phase (U, V, W) coils, respectively, to configure a parallel connection circuit for each phase; and
a circular conductive pattern arranged around a through-hole formed in a central portion of the auxiliary printed circuit board (PCB) and having end lines of the 3-phase (U, V, W) coils arranged inside the 3-phase (U, V, W) coils connected in common to form a Y-connection type neutral point (N) of the 3-phase (U, V, W) coils.

10. The water pump of claim 8, further comprising:
a support shaft accommodation part formed to extend to the lower space to form a groove from the center of the partition wall;
a support shaft having a lower end portion fixed through the groove of the support shaft accommodation part;
a bearing housing extending from the center of the rotor support supporting the rotor to the inside of the groove of the support shaft accommodation part; and
a sleeve bearing installed at an inner circumferential portion of the bearing housing to rotatably support the rotor about the support shaft.

11. The water pump of claim 8, wherein
the electric motor comprises a BLDC motor having a 12-pole-9 slot, or an 8-pole-6 slot structure, and
the 3-phase (U, V, W) coils are split into and wound on nine or six windings and form a series connection circuit or parallel connection circuit for each of U, V, and W phases.

12. The water pump of claim 8, wherein the pump housing comprises:
a pump cover at the center of one side end of which an inlet through which a fluid such as cooling water is introduced is arranged, at one side of which an outlet through which the introduced fluid is discharged is extended, and the center of the other end of which is open;
a body case which covers the opening of the pump cover by the partition wall to form a fluid flow passage inside the pump cover, and is formed in an inverted cup shape so as to have a lower space outside the lower side of the fluid flow passage; and
an upper cover coupled to a lower side of the body case to form a sealed lower space therein, and having the stator of the electric motor embedded in the lower space.

13. The water pump of claim 8, wherein the magnet of the rotor is an open structure exposed to the fluid, and the magnet of the rotor is a ferrite magnet.
